(19) United States
(12) Patent Application Publication
(10) Pub. No.: US 2003/0155290 A1
(43) Pub. Date: Aug. 21, 2003

(54) Multichannel element and method for making same

(76) Inventor: Philippe Chanaud, Tarbes (FR)

Correspondence Address: BIRCH STEWART KOLASCH & BIRCH, PO BOX 747, FALLS CHURCH, VA, 22040-0747, US

(21) Appl. No.: 10/204,350

(22) PCT Filed: Feb. 20, 2001
(86) PCT No.: PCT/FR01/00495

(30) Foreign Application Priority Data
Feb. 21, 2000 (FR) 00/02129

(51) Int. Cl. B01D 63/00

(52) U.S. Cl. 210/321.6; 422/101; 422/129; 137/833; 428/221

(57) ABSTRACT

The invention concerns a multichannel element, comprising at least a first ring of channels intermingled with a second ring of channels. The invention also concerns a method for making such an element, and a module comprising same. The invention is applicable to tangential filtering.

The present invention relates to a multichannel element made of an organic or inorganic, porous material, intended for the filtration, the separation or the contacting of liquid or gaseous fluids, for example microfiltration, ultrafiltration, nanofiltration, pervaporation, reverse osmosis, for membrane (bio)reactors, for gas diffusers, for liquid or gas/liquid or gas contactors, for catalysis or for fuel cells. The invention also relates to a method of manufacturing such a multichannel element.

Such multichannel elements may be defined as elements having an elongate shape with respect to their main axis and are pierced by holes or channels oriented along this same axis. The main section of the element may be defined as the section perpendicular to this main axis. In general, this section is constant along the axis and the three-dimensional shape of the element therefore has a symmetry of extrusion. This symmetry therefore makes it possible to define the extruded volume by its main section and its main axis, which axis is then a direction vector or generatrix of the shape of the element. Because of this symmetry of extrusion, the geometry of the multichannel element can therefore be reduced to the shape of its main section. The external perimeter of this main section may be of circular, polygonal or other shape (for example multilobate). The inside of this section has a number of holes N which corresponds to the number of channels of the element. The element is said to be multichannel if N>1. The case in which N=1 corresponds to a single-channel element which is generally of tubular shape and is therefore excluded from the scope of this invention.

Various types of geometry of multichannel filtering elements are already known.

There is the structure with concentric rings, the simplest geometry of which is an external cylindrical geometry pierced by channels which are also cylindrical (cf. FIG. 1). In this case, the section has the shape of a disk, the external perimeter of which is therefore a circle and this section is pierced by N round holes. The round holes are arranged uniformly on one or more concentric circles. This geometry with concentric successive rings is typical of the prior art. In all cases, these successive rings of channels are separated by a ring of material (cf. reference 3 in FIG. 1). The successive rings of material may be defined as a continuous space of material coaxial with the main section. These rings of material match the arrangement of the channels along their ring. Thus, between two successive rings of channels arranged along a circle concentric with the axis of the main section, the ring of material is in the form of a continuous ring centered on the main section.

This ring of material, being coaxial with the center of the part, has the major drawback of being oriented perpendicular to the direction of flow of the fluid and therefore not optimized for extracting the filtered fluid. This ring of material also has the disadvantage of being a wasted space for distributing the channels. Thus, the overall number of channels distributed over the section of the multichannel element is limited by this constraint that the ring of material represents. The filtration surface area of the element, represented by the combination of the surface areas of all the channels, is reduced by this constraint.

Document EP-A-0 686 424 discloses an inorganic multichannel fluid filtration element whose channels lie on a single circle. Document EP-A-704236 discloses a porous monolithic support for a filtration membrane of circular or hexagonal external shape, having a single ring of channels. These two documents do not disclose a multichannel element having several rings of channels or having a ring of channels combined with a central channel. The drawback with these geometries is that they have filtering surface areas limited by the constraint of using only one ring of channels.

Document EP-A-0 778 073 discloses inorganic elements for filtering a fluid medium, having one or two concentric rings of channels and a central channel. These elements have a circular outer contour; they also have a continuous coaxial annulus of material between, on the one hand, the two rings of channels and, on the other hand, the central channel and the ring of channels surrounding it. This geometry has the same drawbacks and limitations as the geometries with concentric rings of channels described above.

There is also a geometry based on a regular paving of square-shaped channels. The advantage of this geometry for a filtration support is the optimum paving of the main section of the element. All the channels have the same shape and the same size. This geometry is optimized in terms of the surface area developed by the multichannel element. The problem with this geometry often stems from its compactness and from the long path between the various channels toward the outer surface of the element.

Document EP-A-0 899 003 proposes to optimize this passage by creating communications between various channels for extracting the filtered fluid and by blocking the end of certain channels. Industrial implementation of such modifications of the honeycomb structure have often proved to be complicated and difficult to carry out on an industrial scale.

Document WO-A-00/29098 discloses a porous monolithic support comprising a first set of channels having similar sections, in the central part of the support, which are separated from one another by more or less radially oriented walls having a common region along the axis of the support, and at least a second set of channels having a peripheral arrangement around the first set of channels. The structure disclosed in that document does not, however, allow the problems encountered with the aforementioned prior art to be solved.

The aim and the object of the present invention are to alleviate the drawbacks of the prior art.

For this purpose and according to a first aspect, the invention provides a multichannel element comprising at least a first ring of channels which is intermingled with a second ring of channels.

According to one embodiment, each of the partitions provided between the channels of said first and second rings is nonperpendicular to the straight line passing through the center of said first and second rings and the middle of the partition in question. Each of the partitions provided between the channels of said first and second rings and the straight line passing through the center of said first and second rings and the middle of the partition in question advantageously makes an angle of between 0 and 60 degrees, preferably between 0 and 45 degrees.

According to another embodiment, the degree of crossover between said first ring and said second ring is at least equal to 0.4.

According to another embodiment, said first and second rings are either circular or hexagonal.

According to another embodiment, the channels of said first and second rings each have a shape chosen from the following general shapes:

diamond;

flattened diamond;

triangle, preferably a substantially isosceles or right-angled triangle;

trapezium, preferably a substantially right-angled trapezium;

half an orange segment.

According to another embodiment, the number of channels of said second ring is preferably equal to the number of channels of said first ring. As a variant, the number of channels of said second ring is twice the number of channels of said first ring.

According to another embodiment, the channels of said first ring all have the same shape. Preferably, the channels of said second ring have a shape different from the channels of said first ring. It is advantageous for the channels of said second ring all to have the same shape.

According to another embodiment, said second ring consists of a plurality of pairs of adjacent channels, each of said pairs of adjacent channels comprising a first channel and a second channel symmetrical with the first channel with respect to a straight line passing through the center of said rings. Preferably, each of said pairs of channels is arranged between two successive channels of said first ring. It is advantageous that the number of rings of channels be two and in that the channels of said first ring have the general shape of a flattened diamond and the channels of said second ring to have the general shape of half an orange segment. As a variant, a third ring of channels is intermingled with said first ring, said third ring having the same number of channels as said first ring, and in that the general shape of the channels of said first and third rings is a diamond or flattened diamond and the general shape of the channels of said second ring is a triangle, preferably a substantially right-angled or isosceles triangle, or a trapezium, preferably a substantially right-angled trapezium.

According to another embodiment, the shape of the channels of said rings is provided with joining fillets. Moreover, the channels or said pairs of adjacent channels of said first and second rings are advantageously arranged at regular intervals along their respective ring.

The multichannel element may furthermore include a central channel which is preferably circular or a regular polygon.

Moreover, the partitions provided between the channels of said rings preferably have substantially the same thickness. As a variant, the partitions provided between the channels of said rings may progressively widen out when starting from their end directed toward the interior of said multichannel element and go toward their end directed toward the external of said multichannel element.

According to a second aspect, the invention provides a multichannel element comprising a ring of channels which is intermingled with a central channel. The ring of channels preferably comprises 3 or 4 channels. The central channel advantageously has the general shape of a triangle. Said ring advantageously consists of three channels in the shape of an orange segment. The external outline of said element is preferably circular.

According to a third aspect, the invention provides a method of manufacturing a multichannel element according to the invention, in which said multichannel element is obtained by extrusion.

A multichannel element according to the invention is an element of elongate shape, a shape being oriented along a main axis and containing N channels oriented along this same axis. In the present description, this main axis is called the longitudinal axis and the section perpendicular to this main axis is called the cross section. The structure and the dimensions of the cross section of the element are preferably identical over the entire length of the element.

The description will always be given by considering a cross section of the multichannel element.

The channels are arranged inside the element so as to form at least one ring of channels. A ring of channels is defined as a set of channels lying on a closed curve, called a channel carrier curve. A channel lies on a given closed curve if its center of mass lies on this curve. In general, the channels preferably lie on a circle, in which case the ring is called a circular ring. As a variant, the channels may lie along the sides or on the vertices of a polygon, preferably a regular polygon. The ring will then be called a polygonal ring. Advantageously, it may be a hexagon, in which case the ring is called a hexagonal ring. Moreover, two channels are said to be neighboring or adjacent if they have one and the same wall in common; this common wall then constitutes a partition separating the two channels.

According to a first aspect, the invention provides an element comprising at least a first ring of channels which is intermingled with a second ring of channels. In this case, the second ring surrounds the first ring in the sense that the curve carrying the second ring surrounds the curve carrying the first ring. Preferably, the two rings have the same shape, this being advantageously chosen to be either circular or a regular polygon, in particular a hexagon. In addition, the two rings are preferably centered on the longitudinal axis of the element. It is advantageous for the carrying curves—circle, hexagon or the like—on which the channels of the two intermingled rings lie, are preferably derived from one another by homothety with respect to the longitudinal axis of the element. It is also advantageous for the external outline of the element to have the same shape as the intermingled rings, or at least the same shape as the ring closest to the outer periphery of the element.

The notion of two rings mingling may be defined by means of the notion of the mingling radius of a channel.

For a given channel of a circular ring, the radius of mingling is the greatest distance between the channel carrier circle of the ring and the wall of this channel measured along the radii of this carrier circle.

For a given channel of a polygonal ring, the radius of mingling is the greatest distance between that side of the channel carrier polygon on which this channel lies and the wall of this channel measured perpendicular to this side. If the center of mass of the channel is placed at the vertex formed by two sides of the polygon, a radius of mingling may then be defined with respect to each of these sides.

From these definitions and for each channel, an inner radius of mingling and an outer radius of mingling may be defined. The inner radius of mingling is the radius of mingling measured for that part of the wall of the channel on the side toward the center of the ring. The outer radius of mingling is the radius of mingling measured for that part of the wall of the channel on the side toward the outside of the ring.

The radii of mingling may have their origin outside the channel. This is because, in the case of a channel having concave shapes, the center of mass may lie outside the channel. The ring carrier curve then passes at least partly outside the channel and the measurement of the radius of mingling may therefore have its origin outside the channel. On the other hand, the other point of the measurement necessarily lies on the surface of the wall of the channel.

The first ring and the second ring surrounding the first ring are intermingled if, for two neighboring channels, one belonging to the first ring and the other to the second ring:

D<rₒᵤₜ₁+rᵢₙ₂ [relationship 1]

where:

D=distance between the first ring and the second ring, the rings being taken in the region of both channels in question;

rₒᵤₜ₁=outer radius of mingling of the channel of the first ring;

rᵢₙ₂=inner radius of mingling of the channel of the second ring.

In the case of two circular and concentric rings:

D=R₂−R₁

where:

R₁=radius of the carrier circle of the first ring;

R₂=radius of the carrier circle of the second ring.

To verify relationship 1 in the case of two homothetic polygonal rings, the neighboring channels in question lie in one case on one side—called side A₁—of the carrier polygon of the first ring and in the other case on the corresponding side—called side A₂—of the carrier polygon of the second ring. The distance D is then equal to the distance between the side A₁ and the side A₂ measured perpendicular to these two sides. In the particular case of carrier curves in the form of a regular hexagon or of another regular polygon, the distance D then corresponds to the difference in length of the apothems of the two carrier hexagons. If the channels lie on the vertices of the carrier polygon, relationship 1 for a given channel may be successively verified with respect to each of the two sides forming the vertex on which this channel lies. If the sides of the two carrier polygons are not parallel—that is to say the polygons are not homothetic—the distance D is then equal to the shortest distance between the side A₁ and the side A₂.

The multichannel elements having circular and concentric rings of round channels of the prior art are excluded from the definition of intermingled rings according to the present invention. This is because in that case, the difference in radii between the carrier circles of two successive rings is greater—and not less—than the sum of the radii of mingling of any two neighboring channels carried in one case by a first of these rings and in the other case by the second of these rings, the radii of mingling being measured from the side closest to the neighboring channel. The difference stems from the thickness of the ring of material which separates the two rings of channels. In the example shown in FIG. 1, which illustrates a cross section of a typical element of the prior art having two circular and concentric rings 1 and 2 of round channels, the distance D, which is the difference in radii R₂−R₁ between the two carrier circles 4 and 5 of the two rings and is equal in this case to 2.8 mm, is greater than the sum of the radii of mingling rₒᵤₜ₁+rᵢₙ₂ of the neighboring channels, equal in this case to 1+1=2 mm. The difference stems from the thickness E of the ring of material 3, equal in this case to 0.8 mm.

It is advantageous that relationship 1 be verified for all the neighboring channels of the two rings of channels in question.

Moreover, it is also possible to define a degree of crossover T of the two rings with respect to their carrier curves. The degree of crossover may be defined by:

T=(rₒᵤₜ₁+rᵢₙ₂)/D−1 [relationship 2]

where rₒᵤₜ₁, rᵢₙ₂ and D have the same meaning as in the case of relationship 1.

The degree of crossover T between the first ring and the second ring is advantageously at least 0.3, preferably 0.4 and more preferably at least 0.5.

According to a preferred embodiment, each of the partitions provided between the channels of the first and second rings is not perpendicular to the straight line passing through the center of the first and second rings and the middle of the partition in question. The expression “partition between the channels” should be understood to mean any wall separating two neighboring channels both belonging to one and the same ring or belonging in one case to the first ring and in the other case to the second ring. A partition is therefore bounded on each side by the two neighboring channels in question. In the present invention, the partitions are preferably approximately plane. In this case, each partition is bounded on each side by a respective straight side participating in the definition of the outline of a corresponding channel among the two neighboring channels in question. Of course, these two straight sides are approximately facing each other. The partition is then bounded lengthwise by the imaginary segment joining the corresponding ends of the aforementioned straight sides. In the preferred case in which the outlines of the channels are provided by fillets, the end of these straight lines will be considered to correspond to the start of the fillet, excluding the fillet itself. The middle of a partition is defined as the point lying on the median line of the partition and at an equal distance, measured along the median line, from the aforementioned imaginary segments by which the partition in question is bounded.

It will be considered within the context of the present invention that a partition provided between two neighboring channels is not perpendicular to the straight line passing through the center of the first and second rings and the middle of the partition in question if the median line of the partition is not perpendicular to the aforementioned straight line. If the median line of a partition is not a straight line, for example if it is curved, its overall orientation will be considered instead of the median line.

According to another advantageous embodiment of the invention, the shape of the longitudinal channels in their cross section is defined so as to obtain separating partitions between them which have an approximately constant thickness. In fact, in one particularly advantageously embodiment, the separating partitions between channels gradually widen starting with a minimum thickness from their inwardly directed end before ending with a maximum thickness at their end directed toward the outer periphery of the multichannel element in question, this having the effect of making it easier for the permeate to be extracted toward the outside as EP-A-0 609 275 teaches. The minimum thickness or the maximum thickness of a partition is defined by the distance measured along a perpendicular to the median line of this partition passing through the end of one of the sides defining the partition, the perpendicular cutting the other side defining the partition; should this other side not be cut, the perpendicular to the median line passing through the end of this other side will be considered. If the channels are provided by fillets, the end of one side of a partition will be considered as corresponding to the start of the fillet, excluding the fillet itself as already mentioned above.

In the invention, the shape of these channels is defined so as to optimize the mingling of the channels. This mingling allows better distribution of the channels over the section of the element. The channels of any one ring are preferably all identical (including by symmetry), but it is advantageous to have at least two different channel shapes in respect of all of the rings of channels. If all the channels of a given ring have the same shape, these channels are preferably all arranged on the carrier curve of the ring with the same inclination with respect to this curve. As a variant, it may be advantageous to combine the channels on any one ring in pairs, each pair comprising a first channel with a given shape and an adjacent channel with a shape symmetrical to the first with respect to a straight line passing through the center of the ring. Preferably, the channels or the pairs of channels in the aforementioned variant are uniformly distributed over the carrier curve of the ring.

Of course, the multichannel element may comprise more than two rings of channels for which two successive rings correspond each time to the features of the invention. It is also possible to have in the same multichannel element rings of channels according to the invention and other rings of channels made according to the prior art.

According to a second aspect, the invention provides a multichannel element comprising a ring of channels which is intermingled with a central channel. If the ring of channels is circular, it will be considered to be intermingled with the central channel if the radius of the carrier circle of the channels of the ring is less than the sum of the maximum radius of the central channel and of the inner radius of mingling of a channel of the ring. The definition of the inner radius of mingling is that defined above. It is preferred that all the channels of the ring satisfy this relationship.

The intermingled structure of the multichannel elements according to the invention offers a first advantage of having large filtration surface areas which correspond to the sum of the surface areas of the various channels. This is because a larger number of channels may be distributed over the section of the element compared with geometries having concentric rings of channels. This is because, in these geometries, the rings of material form annuli which define spaces not used for distributing the channels and therefore reduce the number of the latter. With intermingled rings of channels, this larger number of channels for a constant hydraulic diameter makes it possible to obtain higher surface areas for filtration, this representing a criteria of paramount importance in the case of filtering elements.

A second advantage of this geometry corresponds to better extraction of the filtered liquid through the multichannel element. The fact of having intermingled rings of channels with the inter-channel partition preferably oriented so as to be not perpendicular to the straight line passing through the center of the rings and the middle of the partition in question, means that these partitions form a fluid extraction system which is completely branched and oriented generally radially—from the center toward the outside—of the section of the element. The element according to the invention therefore does not have the drawback of a system having concentric rings of channels in which the rings of material form annuli which are centered on the part and are not optimized for extracting the fluid since they are, on the contrary, oriented perpendicular to the radial overall flow direction of the filtered fluid.

A third advantage of this geometry corresponds to the better distribution of the pressure differences between the inside of the channels and the outside of the element.

A fourth advantage of this invention stems from the better mechanical behavior of this type of geometry. This is because a geometry consisting of intermingled rings of channels has a distribution of material which creates a truly intermingled framework allowing better distribution of the mechanical stresses through the entire multichannel element.

In general, the multichannel elements according to the invention are optimized from the standpoint of their filtration surface area and their mechanical and hydrodynamic properties.

Further features and advantages of the invention will become apparent on reading the description which follows of embodiments of the invention, the description being given by way of nonlimiting example and with reference to the appended drawing in which:

FIG. 1 shows a cross section of a multichannel element having two circular and concentric rings of round channels of the prior art;

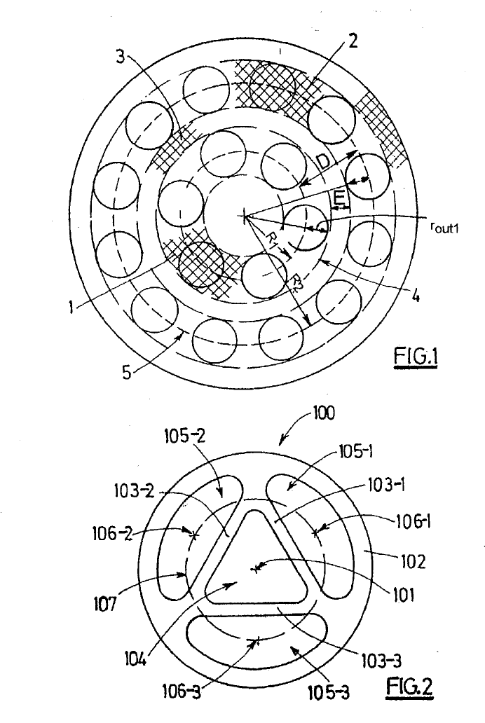

FIG. 2 shows a cross section of a multichannel element 100 corresponding to a first embodiment of the invention;

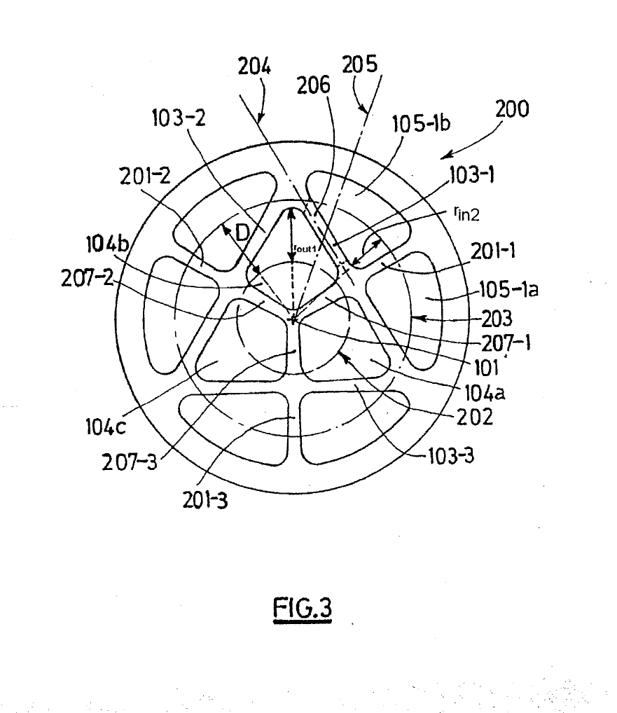

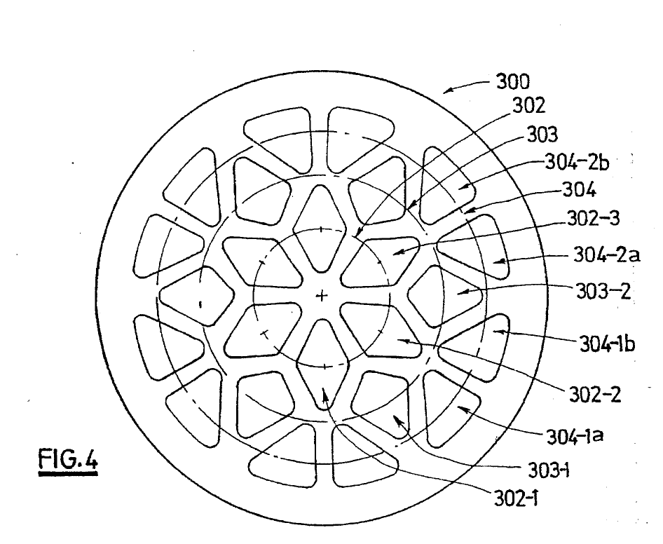

FIG. 3 shows a cross section of a multichannel element 200 corresponding to a second embodiment of the invention;

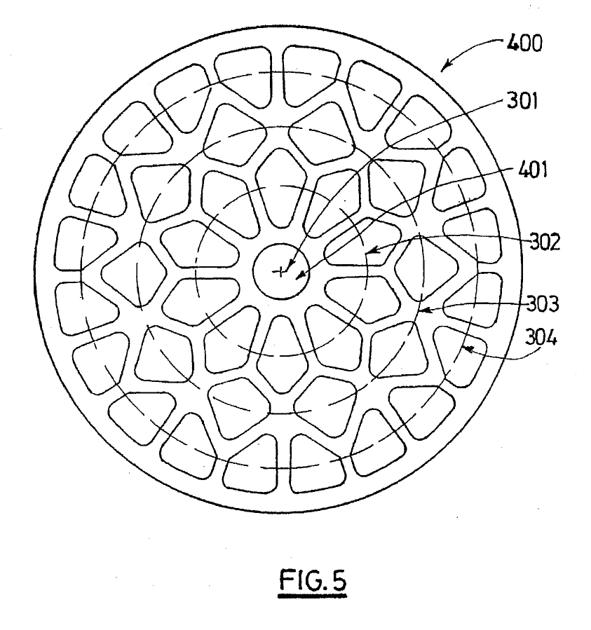

FIG. 4 shows a cross section of a multichannel element 300 corresponding to a third embodiment of the invention;

FIG. 5 shows a cross section of a multichannel element 400 corresponding to a fourth embodiment of the invention;

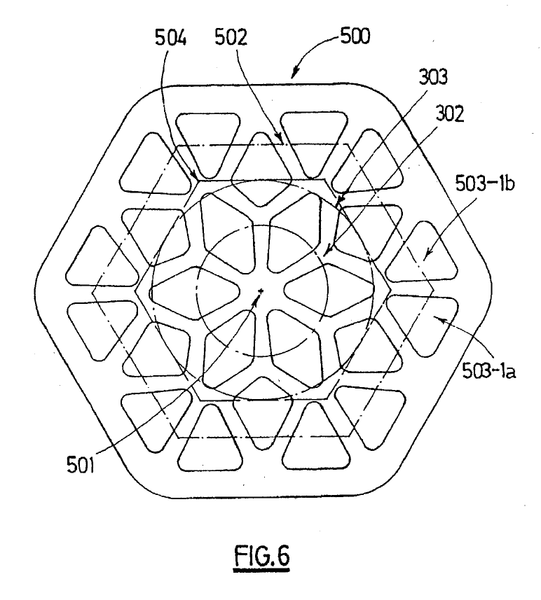

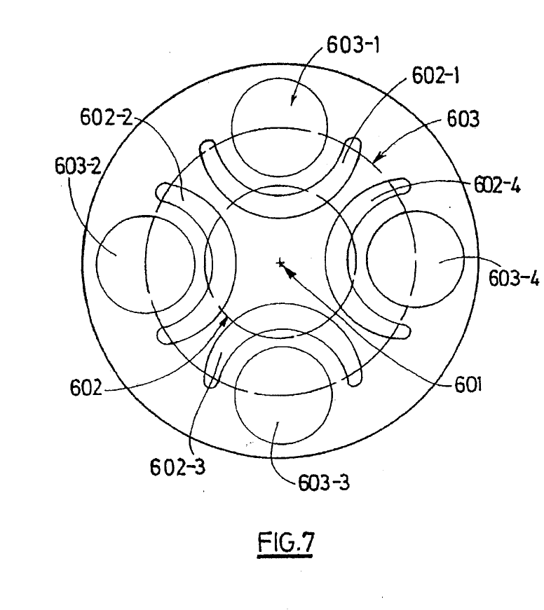

FIG. 6 shows a cross section of a multichannel element 500 corresponding to a fifth embodiment of the invention; and

FIG. 7 shows schematically a cross section of a multichannel element 600 corresponding to a sixth embodiment of the invention.

FIG. 2 shows a cross section of a multichannel element 100 corresponding to a first embodiment of the invention.

The multichannel element 100 is of the type having a ring of channels which is intermingled with a central channel.

The multichannel element 100 comprises an outer wall 102 in the form of a round tube having a longitudinal axis. The outer wall 102 preferably has an approximately constant thickness over its entire circumference.

Three longitudinal plane partitions 103-1, 103-2 and 103-3 are provided inside the round tube formed by the outer wall 102, in order to divide the inside of the multichannel element 100 into four longitudinal channels. In cross section, the three partitions 103-1, 103-2 and 103-3 form an equilateral triangle, the center of which is coincident with the longitudinal axis 101 and the vertices of which are joined to the outer wall 102. The partitions 103-1, 103-2 and 103-3 each have a constant thickness identical to the thickness of the other partitions. Preferably, a fillet is provided at each join between two successive partitions. Likewise, each vertex of this triangle is advantageously joined to the outer wall 102 by means of two fillets symmetrical with respect to the bisector of the angle made by the vertex in question.

A first longitudinal channel 104 is defined by the space inside the equilateral triangle formed by the three partitions 103-1, 103-2 and 103-3 and therefore constitutes a central channel. Three other longitudinal channels 105-1, 105-2 and 105-3 are defined between each of the partitions 103-1, 103-2 and 103-3, respectively, and the outer wall 102. The channels 105-1, 105-2 and 105-3 all have the same cross section in the shape of an orange segment because of the configuration, in the form of an equilateral triangle, of the partitions 103-1, 103-2 and 103-3 which is centered on the longitudinal axis 101. It follows from this geometry that the channels 105-1, 105-2 and 105-3 each have their respective center of mass 106-1, 106-2 and 106-3 lying on a circle 107 centered on the longitudinal axis 101 and these three channels are equally inclined to this circle 107.

To give an example with dimensions, the multichannel element 100 has an outside diameter of 10 mm and the thickness of the outer wall 102 is 0.8 mm. The thickness of the partitions 103-1, 103-2 and 103-3 is 0.5 mm. The radius of the imaginary circle passing through the vertices of the triangular channel 104 which are rounded by the fillets is 2.5 mm. The joining fillets have a radius of 0.5 mm in the case of the channel 101 and a radius of 0.7 mm in the case of the channels 105-1, 105-2 and 105-3. The radius of the circle 107 is 3 mm. This results in a mean hydraulic diameter, averaged over all of the channels, of 3.1 mm and a filtering surface area of 0.014 m² in the case of a multichannel element 100 having a length of 250 mm.

FIG. 3 shows a cross section of a multichannel element 200 corresponding to a second embodiment of the invention.

The multichannel element 200 has the same structure as the multichannel element 100 of the first embodiment of the invention, except that six additional partitions 201-1, 201-2, 201-3, 207-1, 207-2 and 207-3 have been added to it. The partitions 201-1 and 207-1 are plane and longitudinal. Partition 207-1 is perpendicular to the partition 103-1 and extends from the longitudinal axis 101 as far as the partition 103-1. The partition 201-1 is also perpendicular to the partition 103-1, but lies along the extension of the partition 207-1 from the partition 103-1 as far as the outer wall 102. As a result, the partitions 103-1, 103-2 and 103-2 of the multichannel element 100 are each divided into two channel-separating partitions.

Preferably, the partitions 201-1 and 207-1 are joined respectively to the partition 103-1 by means of two radially symmetrical fillets. Likewise, the partition 201-1 is joined to the outer wall 102 preferably by means of two radially symmetrical fillets. The partitions 201-2 and 201-3 are obtained from the partition 201-1 by successive rotation through an angle of 2π/3 with respect to the longitudinal axis 101. Likewise, the partitions 207-2 and 207-3 are obtained from the partition 207-1 by successive rotation through an angle of 2π/3 with respect to the longitudinal axis 101. The three partitions 207-1, 207-2 and 207-3 are joined in pairs along the longitudinal axis 101, preferably by means of a respective fillet.

As a result, the channel 104 of triangular cross section of the first embodiment of the invention is subdivided into three longitudinal channels 104a, 104b and 104c each having the same cross section in the shape of a flattened diamond. The term “flattened diamond” should be understood to mean the external outline of two isosceles triangles of different height joined together by a common base, with the vertices of the triangles lying on either side of the common base. Moreover, the three channels 105-1, 105-2 and 105-3 having a cross section in the shape of an orange segment in the first embodiment of the invention are each subdivided into two channels having a cross section radially symmetrical with respect to each other. In FIG. 3, only the two channels resulting from the division of the channel 105-1 have been labeled, namely 105-1a and 105-1b. The number of longitudinal channels is therefore increased to nine.

It follows from the geometry adopted that the three channels 104a, 104b and 104c are arranged on a first circle 202 centered on the longitudinal axis 101 and the other six channels are arranged on a second circle 203 centered on the longitudinal axis 101 and surrounding the first circle 202. The channels lying on the first circle 202 are all equally inclined to this circle. Likewise, the pairs of symmetrical channels lying on the second circle are all equally inclined to the circle. The three channels 104a, 104b, 104c form a first circular ring and the other six channels form a second circular ring.

The two circular rings are intermingled since relationship 1 is obviously satisfied. As an illustration, D, Rₒᵤₜ₁ and Rᵢₙ₂ have been shown for the neighboring channels 104b, 105-1b.

Moreover, the two partitions 201-1 and 207-1 each obviously make a zero angle with the straight line passing through their middle and the center of the two rings of channels. The same applies for the partitions 201-2, 201-3, 207-2 and 207-3.

The two inter-channel separating partitions resulting from dividing the partition 103-1 by the partitions 201-1 and 207-1 are quite obviously not perpendicular to the straight line passing through its middle and the center of the two rings of channels. As an illustration, the median line 204 of the separating partition 26 between the channel 104b and the channel 105-1b has been shown. The ends of this separating partition 206 has been shown dotted. The straight line passing through the middle of the partition 206 and the center of the rings of channels—that is to say the radius of the rings passing through the middle of the partition 206—has been labeled 205. The same obviously applies in the case of the other inter-channel separating partitions resulting from dividing the partitions 103-2 and 103-3 by the partitions 201-2 and 207-2 and 201-3 and 207-3, respectively.

To give an example with dimensions, the multichannel element 200 has an outside diameter of 25 mm and the thickness of the outer wall 102 is 2 mm. The radius of the circle centered on the longitudinal axis 101 and passing through the vertices of the channels 104a, 104b and 104c, rounded by the fillets, is 7.8 mm. The joining fillets have a radius of 1 mm. The thickness of the partitions 103-1, 103-2 and 103-3 gradually increases from 0.8 mm starting from the corresponding partitions 201-1, 201-2 and 201-3 to end at 1 mm at the opposite ends toward the outside of the element 300. The thickness of the partitions 207-1, 207-2 and 207-3 varies in the same manner from the longitudinal axis 101 toward the corresponding partitions 103-1, 103-2 and 103-3, as does the thickness of the partitions 201-1, 201-2 and 201-3 starting from these partitions 103-1, 103-2 and 103-3 as far as the outer wall 102. In this example, it follows that the radius of the circle 202 is 3.9 mm and the radius of the circle 203 is 8.3 mm. This results in a mean hydraulic diameter averaged over all of the channels of 5.6 mm and a filtering surface area of 0.23 m² in the case of a multichannel element 200 having a length of 1200 mm. In addition, the dimensional ratios of rₒᵤₜ₁ and rᵢₙ₂ to D resulting from this dimensional example make it possible to obtain a degree of crossover T of about 0.53 and an angle between the inter-channel separating partitions resulting from dividing the partitions 103-1, 103-2 and 103-3 and the radius passing through their middle of about 51 degrees.

FIG. 4 shows a cross section of a multichannel element 300 corresponding to a third embodiment of the invention.

The external shape of the multichannel element 300 is that of a round straight tube having a longitudinal axis 301. The internal space of the multichannel element 300 is subdivided into three series of longitudinal channels. In cross section, the longitudinal channels of each of these three series are arranged on a respective circle 302, 303 and 304, forming three circular rings. The three circles 302, 303 and 304 are preferably concentric and centered on the longitudinal axis 301. The radius of the circle 302 is smaller than that of the circle 303 and the radius of the circle 303 is smaller than that of the circle 304.

The longitudinal channels lying on the inner circle 302 are six in number; only two are labeled in FIG. 4, by 302-1 and 302-2. In cross section, the longitudinal channel 302-1 has the shape of a diamond, one of the two axes of which cuts the longitudinal axis 301. The corners of the diamond thus formed are preferably provided with a respective fillet. The other five longitudinal channels lying on the inner circle 302 have the same cross section as the channel 302-1 and are derived from the latter by successive rotation through an angle π/3 with respect to the longitudinal axis 301.

The longitudinal channels lying on the intermediate circle 303 are also six in number; only two are labeled in FIG. 4, by 303-1 and 303-2. In cross section, the longitudinal channel 303-1 has the shape of a flattened diamond—cf. definition of the flattened diamond given in relation to FIG. 3. The axis of this deformed diamond, which is perpendicular to the common base of the triangles forming the flattened diamond, cuts the longitudinal axis 301. The corners of this flattened diamond are preferably provided with a respective fillet. The other five longitudinal channels lying on the intermediate circle 303 have the same cross section as the channel 303-1 and are derived from the latter by successive rotation through an angle π/3 with respect to the longitudinal axis 301.

As may be seen in FIG. 4, each of the channels lying on the intermediate circle 303 is imbricated between two respective successive channels lying on the inner circle 302. For example, it may be seen that the channel 303-1 lies partly between the channels 302-1 and 302-2. The channels of the circle 302 are advantageously offset by an angle π/6 with respect to the channels of the circle 303.

The longitudinal channels lying on the outer circle 304 are twelve in number; only four are labeled in FIG. 4, by 304-1a, 304-1b, 304-2a and 304-2b. In cross section, the longitudinal channel 304-1a has the overall shape of a right-angled triangle, although the angle in principle a right angle, is in fact 78 degrees in the example illustrated because of the external curvature of the multichannel element. A first side of this triangle is approximately parallel and slightly offset with respect to a radius of the external outline of the multichannel element 300 and its end furthest from the longitudinal axis 301 makes the approximately right angle of the triangle with a second side which lies in the opposite direction to the radius of the aforementioned external outline. In fact, it is preferable that this first side be approximately oriented toward the longitudinal axis 301 in order to define a wedge-shaped partition, progressively widening from the inside toward the outside of the multichannel element 300. Moreover, the second side of the triangle may be advantageously circular and concentric with the external outline of the multichannel element 300 instead of being a straight line, in order to obtain an outer wall of constant thickness. The corners of this triangle are preferably provided with a respective fillet. The longitudinal channel 304-1b is adjacent to the channel 304-1a and is symmetrical with the latter with respect to the radius of the external outline of the element 300 to which the first aforementioned side of the triangle formed by the channel 304-1a is parallel and slightly offset. The other five pairs of longitudinal channels lying on the outer circle 304 have the same cross section as the pair of channels 304-1a and 304-1b and are derived from the latter by successive rotation through an angle π/3 with respect to the longitudinal axis 301. As may be seen in FIG. 4, each pair of successive channels lying on the outer circle 304 is imbricated between two respective successive channels lying on the intermediate circle 303. For example, it may be seen that the channels 304-1a and 304-1b lie partly between the channels 303-1 and 303-2. The pairs of channels of the circle 304 are advantageously offset by an angle π/6 with respect to the channels of the circle 303.

As may be seen in FIG. 4, the ring of channels of the inner circle 302 and the ring of channels of the intermediate circle 303 are intermingled. Likewise, the ring of channels of the intermediate circle 303 and the ring of channels of the outer circle 304 are also intermingled, relationship 1 being satisfied in both cases.

To give an example with dimensions, the multichannel element 300 has an outside diameter of 25 mm and the thickness of the outer wall at the channels lying on the circle 304 is 2 mm. The thickness of the partitions between the various longitudinal channels progressively increases from 0.8 mm at its end directed toward the inside, to end at 1 mm at its opposite end directed toward the outside of the element 300. The radius of the circle 302 is 3.8 mm, the radius of the circle 303 is 6.7 mm and the radius of the circle 304 is 9.1 mm. For each channel of the circle 302, the diamond has a length of 5 mm along its axis cutting the longitudinal axis 301 and a width of 3 mm along its axis perpendicular to the longitudinal axis. For each channel of the circle 303, the flattened diamond has a common base of 3.4 mm, with the isosceles triangle pointing toward the longitudinal axis 301 having a height of 1.5 mm and the other isosceles triangle a height of 2.7 mm. For each channel of the circle 304, that side of the right-angled triangle which is parallel to a radius of the element 300 has a length of 2.55 mm and that side which is perpendicular to the latter has a length of 2.85 mm. These dimensions are given, from one fillet to the other, for each shape of channel, each fillet having a radius of 0.5 mm. This results in a mean hydraulic diameter, averaged over all of the channels, of 3 mm and a filtering surface area of 0.35 m² for an element 300 having a length of 1.2 m. In addition, the ratios of the dimensions resulting from this example with dimensions make it possible to obtain a degree of crossover T of about 0.5 in the case of the rings of circles 302 and 303 and about 0.83 in the case of the rings 303 and 304. An angle between the inter-channel separating partitions of the circles 302 and 303 and of the circles 303 and 304, with respect to the radius passing through their middle, of about 40 and 37 degrees respectively is obtained.

FIG. 5 shows a cross section of a multichannel element 400 corresponding to a fourth embodiment of the invention.

The multichannel element 400 is based on a structure similar to that of the multichannel element 300 shown in FIG. 4. The detailed description given with regard to the multichannel element 300 also applies to the multichannel element 400, with the exception of the following details and modifications. The multichannel element 400 has three series of longitudinal channels lying on the circles 302, 303 and 304 in a similar manner as in the case of the multichannel element 300. The multichannel element 400 furthermore includes a central longitudinal channel 401 of circular cross section concentric with the circles 302, 303 and 304. In cross section, the shape of the channels lying on the circles 302, 303 and 304, their number and the respective radii of the circles 302, 303 and 304 are adapted from the structure of the multichannel element 300, because of the existence of the central channel 401. Thus, the channels lying on the circle 302 are ten in number and are placed comparatively closer to the outside of the element in order to allow the central channel 401 to be provided and have a cross section in the shape of a flattened diamond. As a result, the channels on the circle 302 are derived from one another preferably by rotation through an angle π/5 with respect to the longitudinal axis 301. Similarly, the number of the channels of the circle 303 has been increased to ten, these being advantageously derived from one another by rotation through an angle π/5 with respect to the longitudinal axis 301. Consequently, the number of channels on the circle 304 has been increased to twenty, these being distributed in ten pairs of radially symmetrical channels in a manner similar to that in the case of the element 300. Here again, the pairs of channels are advantageously derived from one another by rotation through an angle π/5 with respect to the longitudinal axis 301. The shape of the channels on the outer circle 304 has been modified. In fact, the overall shape of the right-angled triangle has been extended by backing its second side, which forms the approximately right angle and faces the external outline of the multichannel element 300, with a rectangle having the second side in common with the triangle. The channels consequently have the overall shape of an approximately right-angled trapezium, the tip of which is largely directed toward the longitudinal axis 301, although the two approximately right angles of this trapezium in fact are only 78 degrees in the example illustrated, because of the external curvature of the multichannel element and because the two bases of the trapezium, which are in principle parallel to each other, are preferably each largely directed toward the longitudinal axis 301 in order to form partitions of constant thickness with the neighboring channels. That side of the channel close to the periphery is also preferably circular and concentric with the external outline of the multichannel element 400 instead of being straight, in order to obtain an outer wall of constant thickness. The corners of this trapezium are also preferably provided with a respective fillet. The shape and dimensional modifications are also aimed at harmonizing the hydraulic diameter of the various channels. The channels of the circle 303 are now preferably offset by an angle π/10 with respect to the channels of the circle 302. Likewise, the pairs of channels of the circle 304 are offset by angle π/10 with respect to the channels of the circle 303.

As may be seen in FIG. 5, the ring of channels of the inner circle 302 and the ring of channels of the intermediate circle 303 are intermingled, as are also the ring of channels of the intermediate circle 303 and the ring of channels of the outer circle 304, relationship 1 being satisfied in both cases.

To give an example with dimensions, the multichannel element 400 has an outside diameter of 25 mm and the thickness of the outer wall at the channels lying on the circle 304 is 1 mm. The thickness of the partitions between the various longitudinal channels is 0.6 mm. The radius of the circle 302 is 4.4 mm, the radius of the circle 303 is 7.5 mm and the radius of the circle 304 is 10.3 mm. The central channel 401 has a diameter of 3 mm. For each channel of the circle 302, the flattened diamond has a common base of 2.55 mm with the isosceles triangle pointing toward the longitudinal axis 301 having a height of 2.7 mm and the other isosceles triangle a height of 1.4 mm. For each channel of the circle 303, the flattened diamond has a common base of 3.4 mm with the isosceles triangle pointing toward the longitudinal axis 301 having a height of 1.3 mm and the other isosceles triangle a height of 2 mm. For each channel of the circle 304, the side common to the triangle and to the rectangle has a length of 2.6 mm, the height of the right-angled triangle is 1.6 mm and the width of the rectangle is 1.3 mm. These dimensions are given from one fillet to the other for each channel shape, each fillet having a radius of 0.6 mm. This results in a mean hydraulic diameter averaged over all of the channels of 2.7 mm and a filtering surface area of 0.5 m² for a multichannel element 400 having a length of 1.2 m. In addition, the ratios of the dimensions resulting from this dimensional example makes it possible to obtain a degree of crossover T of about 0.15 for the rings of the circles 302 and 303 and about 0.2 for the rings 303 and 304. An angle between the inter-channel separating partitions of these circles 302 and 303 and of the circles 303 and 304 with respect to the radius passing through their middle of about 49 degrees and 44 degrees respectively is also obtained.

FIG. 6 shows a cross section of a multichannel element 500 corresponding to a fifth embodiment of the invention.

The multichannel element 500 is based on the structure of the multichannel element 300 shown in FIG. 4. The detailed description given with regard to the multichannel element 300 also applies to the multichannel element 500, with the exception of the following details and modifications. The multichannel element 500 has the shape of a hexagonal straight tube instead of that of a round straight tube as is the case with the multichannel element 300. The external outline of the cross section of the multichannel element 500 therefore describes a hexagon whose center obviously lies on the longitudinal axis 501 of the hexagonal tube thus defined. Preferably, the vertices of the hexagon formed by the external outline of the multichannel element 500 are rounded. The internal structure, that is to say the shape and the arrangement of the longitudinal channels, of the multichannel element 300 has been adapted to the hexagonal outline of the element 500. The overall shape and arrangement of the longitudinal channels lying on the circles 302 and 303 have not been modified. On the other hand, the circle 304 and the longitudinal channels lying on this circle have been modified. In cross section, the longitudinal channels which correspond to those lying on the circle 304 of the multichannel element 300 now lie on a hexagon 502. This hexagon 502 is obtained by homothety with a center lying on the longitudinal axis 501 and with a ratio of less than 1, applied to the hexagon formed by the external outline of the multichannel element 500. The longitudinal channels lying on the hexagon 502 have the overall shape of an isosceles triangle. Regarding a first longitudinal channel 503-1a, a first side of the triangle that it forms is approximately parallel and slightly offset with respect to a straight line passing through the center and a vertex of the hexagon 502. That side of the triangle closest to the periphery of the element 500 is parallel to this periphery. The two sides of the triangle which are not parallel to the adjacent periphery of the multichannel element 500 have the same length. The vertices of this triangle are preferably provided by a respective fillet. A second longitudinal channel 503-1b adjacent to the channel 503-1a and is symmetric with the channel 503-1a with respect to the straight line passing through the center of the hexagon 502 and one corner of the latter, to which straight line the aforementioned first side of the triangle formed by the channel 503-1a is parallel and slightly offset. The other five pairs of longitudinal channels lying on the hexagon 502 have the same cross section as the channels 304-1a and 304-1b and are derived from the latter by successive rotation through an angle π/3 with respect to the longitudinal axis 501. As may be seen in FIG. 6, each pair of successive channels lying on the hexagon 502 is imbricated between two respective successive channels lying on the intermediate circle 303 in the same way as in the case of the multichannel element 300. It will be noted that the channels of the carrier circle 303 may also be regarded as lying on a carrier hexagon 504 because of the fact that the number of channels is six and they are obtained from one another by rotation through an angle of π/3. A degree of crossover T between the outer and intermediate rings with respect to the hexagons 502 and 504 and a degree of crossover T′ between the inner and intermediate rings with respect to the circles 302 and 303 may thus be defined. As may be seen in FIG. 6, the ring of channels of the inner circle 302 and the ring of channels of the intermediate circle 303 are intermingled, as are also the ring of channels of the intermediate hexagon 504 and the ring of channels of the outer hexagon 502, relationship 1 being satisfied in both cases. With the ratios of the dimensions illustrated in FIG. 6, a degree of crossover T of 1.4 and a degree of crossover T′ of 0.5 are obtained.

FIG. 7 shows a cross section of a multichannel element 600 corresponding to a sixth embodiment of the invention.

The external shape of the multichannel element 600 is that of a round straight tube. Thus, the external outline of the cross section of the multichannel element 600 describes a circle whose center obviously lies on the longitudinal axis 601 of the round tube thus defined. The internal space of the multichannel element 600 is subdivided into two series of longitudinal channels. In cross section, the longitudinal channels of each of these two series lie on a respective circle 602 and 603. The two circles 602 and 603 are preferably concentric. Moreover, the two circles are advantageously centered on the longitudinal axis 601. The radius of the circle 602 is smaller than that of the circle 603.

The longitudinal channels lying on the inner circle 602 are four in number and are labeled 602-1, 602-2, 602-3 and 602-4. In cross section, the longitudinal channel 602-1 has the shape of a moon crescent lying symmetrically with respect to a radius of the external outline of the multichannel element 600. The tips of the moon crescent are preferably provided with a respective fillet. The other three longitudinal channels 602-2, 602-3 and 602-4 have the same cross section as channel 602-1 and are derived from the latter by a successive rotation through an angle of π/2 with respect to the longitudinal axis 601.

The longitudinal channels lying on the outer circle 603 are also four in number and are labeled 603-1, 603-2, 603-3 and 603-4. In cross section, the longitudinal channel 603-1 has the overall shape of a circle or of an ellipse. If the shape chosen is an ellipse, the minor axis of the ellipse preferably coincides with the radius of the external outline of the multichannel element 600 with respect to which the channel 602-1 is symmetric. In addition, the concave part of the moon crescent formed by the channel 602-1 cradles the circle or ellipse formed by the channel 603-1, or in other words the channel 603-1 lies partly within the concave region of the moon crescent of the cross section of the channel 602-1. The other three longitudinal channels 6032, 603-3 and 603-4 have the same cross section as the channel 603-1 and are derived from the latter by successive rotation through an angle of π/2 with respect to the longitudinal axis 601. As may be seen in FIG. 7, the ring of channels of the inner circle 602 and the ring of channels of the outer circle 603 are intermingled, relationship 1 obviously being satisfied.

In the various embodiments of the invention described in relation to FIGS. 2 to 7, the inter-channel separating partitions may preferably have a constant thickness, but they may more advantageously become progressively wider on going from their end directed toward the inside to their end directed toward the outer periphery of the multichannel element in question, as indicated in the dimensional examples given for each figure.

Moreover, the shape and the dimensions of the various channels are chosen so that their hydraulic radii are equal, to within ±20%, preferably to within ±10%. To do this, it is advantageous for the channels of the inner rings to have the overall shape of a diamond or flattened diamond and also for the channels of the outermost ring to have the overall shape of a triangle or a triangle backed by a rectangle, possibly joined together in symmetric pairs.

The multichannel elements according to the invention preferably have the same cross section over their entire length, thus allowing them to be manufactured by extrusion through a die using, for example, a ceramic paste.

The multichannel element can be used as it is, for example to inject a reaction gas or to form gas/liquid dispersions, liquid/liquid dispersions (emulsions) or the like.

The multichannel element may also be associated with a bacterium (especially an immobilized bacterium) particularly for carrying out aerobic reactions.

The multichannel element may also be associated with a zeolite or a catalyst.

The multichannel elements of the present invention may also be produced in the form of a (macroporous) support on which one or more filtering layers are placed. The membranes thus obtained are particularly suitable for tangential filtration.

Thus, the subject of the invention is also a filtration membrane comprising a multichannel element according to the invention, in combination with at least one filtering layer.

The multichannel elements according to the invention are preferably used in tangential filtration, which implies that the channels are through-channels. They may also be used in frontal filtration, in which case one end of each channel is closed off.

The subject of the invention is also a reaction and/or filtration module comprising at least one multichannel element according to the invention (which multichannel element may or may not be modified) or at least one membrane according to the invention.

The multichannel element is made of a conventional material. For example, it may be made of a sintered ceramic, a sintered metal, porous carbon, a composite, or an organomineral or organic compound. The constituent material may be porous or dense, preferably porous. Preferably, the multichannel elements of the present invention may be made of porous ceramic.

According to one embodiment, the extrusion process comprises conventional steps such as:

(i) the preparation of a mineral paste comprising a mineral part or filler, preferably a binder, and a solvent, optionally with a deflocculant and/or an extrusion aid;

(ii) the forming of said paste by extrusion;

(iii) the consolidation of this form by sintering.

The mineral part of said paste comprises particles of a mineral compound which, after sintering, will form the porous network (homogeneous throughout its volume). The mineral, advantageously metal, compound is either a non-oxide compound or a metal oxide. If it is a non-oxide derivative, a silicon or aluminum derivative, preferably silicon carbide, silicon nitride or aluminum nitride, will be chosen. If the metal compound is an oxide, it will be chosen from the oxides of aluminum, of silicon or of metals from group IVA (titanium group) or group VA (vanadium group), preferably alumina, zirconium oxide or titanium oxide. These oxides may be used alone or as a mixture. The content of mineral compound in the paste will be between 50 and 90 wt %.

The organic binder will give the paste the rheological properties necessary for extrusion and the mechanical properties needed to obtain good cohesion of the product after extrusion. Said organic binder is preferably, but not necessarily, a water-soluble polymer. The polymer will, for example, have, for a 2 wt % solution, a viscosity measured at 20° C. of between 4 and 10 Pa/s. This polymer may be chosen from celluloses and derivatives thereof (HEC, CMC, HPC, HPMC, etc.), or may also be a polyacrylic acid, polyethylene glycol, a polyvinyl alcohol, a microcrystalline cellulose, etc. The paste will contain, for example, between 2 and 10 wt % of organic binder.

The function of the solvent is to disperse the mineral part and the binder. If a water-soluble polymer is used, water will be chosen as solvent; if the polymer is not water-soluble, an alcohol will be chosen as solvent, for example ethanol. The concentration of the solvent will be, for example, between 8 and 40 wt %.

A deflocculant soluble in the solvent will improve the dispersion of the particles of metal compound. For example, a polyacrylic acid, a phosphoorganic acid or an alkyl sulfonic will be chosen. The deflocculant content is around 0.5 to 1 wt %.

In certain cases, an extrusion aid, such as a polyethylene glycol will be added. The extrusion aid content is around 0.5 to 1 wt %.

The forming is conventionally carried out by extrusion. Using a screw or a piston, the paste is pushed through a complex die so as to adopt its geometry. The membrane preforms are collected at the die exit, dried in the open air, so as to remove the water or the solvent, and then sintered at a temperature between 1300 and 1700° C., for example for two hours. This sintering is carried out in a normal or inert atmosphere (for example an argon atmosphere) in the case of a metal-oxide-based paste or in an inert atmosphere (for example an argon or helium atmosphere) if the metal compound is not an oxide.

The extruder is a conventional one, that is to say it includes a die with, placed at the center of the latter, a ring supporting the pins which will form the channels.

The preforms output by the extruder may be dried and/or sintered in rotating drums, for example using the technique described in patent FR-A-2 229 313 in the name of Ceraver.

Thus, as has emerged from the figures and the description above, the subject of the invention is more particularly a multichannel element characterized in that the channel (104) and/or the rings (202, 302, 303, 504; 203, 303, 304, 502; 107) are intermingled at least in pairs, or in other words all the channels or rings are intermingled.

Of course, the present invention is not limited to the examples and embodiments described and shown, rather it is susceptible to many variants within the competence of a person skilled in the art.

1. A multichannel element, comprising at least a first ring of channels (202; 302; 303; 504) which is intermingled with a second ring of channels (203; 303; 304; 502).

2. The multichannel element as claimed in claim 1, characterized in that each of the partitions provided between the channels of said first and second rings is nonperpendicular to the straight line passing through the center of said first and second rings and the middle of the partition in question.

3. The multichannel element as claimed in either of claims 1 and 2, characterized in that each of the partitions provided between the channels of said first and second rings and the straight line passing through the center of said first and second rings and the middle of the partition in question makes an angle of between 0 and 60 degrees, preferably between 0 and 45 degrees.

4. The multichannel element as claimed in any one of claims 1 to 3, characterized in that the degree of crossover between said first ring and said second ring is at least equal to 0.4.

5. The multichannel element as claimed in any one of claims 1 to 4, characterized in that said first and second rings (202, 203; 302, 303; 303, 304) are circular.

6. The multichannel element as claimed in any one of claims 1 to 4, characterized in that said first and second rings (504; 502) are hexagonal.

7. The multichannel element as claimed in any one of claims 1 to 6, characterized in that the channels of said first and second rings each have a shape chosen from the following general shapes:
diamond;
flattened diamond;
triangle, preferably a substantially isosceles or right-angled triangle;
trapezium, preferably a substantially right-angled trapezium;
half an orange segment.

8. The multichannel element as claimed in any one of claims 1 to 7, characterized in that the number of channels of said second ring is equal to the number of channels of said first ring.

9. The multichannel element as claimed in any one of claims 1 to 7, characterized in that the number of channels of said second ring (304; 502) is twice the number of channels of said first ring (303; 504).

10. The multichannel element as claimed in any one of claims 1 to 9, characterized in that the channels of said first ring all have the same shape.

11. The multichannel element as claimed in any one of claims 1 to 10, characterized in that the channels of said second ring have a shape different from the channels of said first ring.

12. The multichannel element as claimed in any one of claims 1 to 11, characterized in that the channels of said second ring all have the same shape.

13. The multichannel element as claimed in any one of claims 1 to 12, characterized in that said second ring (203; 304; 502) consists of a plurality of pairs of adjacent channels (105-1a, 105-1b; 304-1a, 304-1b; 503-1a, 503-1b), each of said pairs of adjacent channels comprising a first channel and a second channel symmetrical with the first channel with respect to a straight line passing through the center of said rings.

14. The multichannel element as claimed in claim 13, characterized in that each of said pairs of channels is arranged between two successive channels of said first ring.

15. The multichannel element as claimed in either of claims 13 and 14, characterized in that the number of rings of channels is two and in that the channels of said first ring (202) have the general shape of a flattened diamond and the channels of said second ring (203) have the general shape of half an orange segment.

16. The multichannel element as claimed in either of claims 13 and 14, characterized in that a third ring (302) of channels is intermingled with said first ring (303), said third ring having the same number of channels as said first ring, and in that the general shape of the channels of said first and third rings is a diamond or flattened diamond and the general shape of the channels of said second ring is a triangle, preferably a substantially right-angled or isosceles triangle, or a trapezium, preferably a substantially right-angled trapezium.

17. The multichannel element as claimed in any one of claims 1 to 16, characterized in that the shape of the channels of said rings is provided with joining fillets.

18. The multichannel element as claimed in any one of claims 1 to 17, characterized in that the channels or said pairs of adjacent channels of said first and second rings are arranged at regular intervals along their respective ring.

19. The multichannel element as claimed in any one of claims 1 to 18, furthermore including a central channel (401) which is preferably circular or a regular polygon.

20. The multichannel element as claimed in any one of claims 1 to 19, characterized in that the partitions provided between the channels of said rings have substantially the same thickness.

21. The multichannel element as claimed in any one of claims 1 to 19, characterized in that the partitions provided between the channels of said rings progressively widen out when starting from their end directed toward the interior of said multichannel element and going toward their end directed toward the external of said multichannel element.

22. The multichannel element, comprising a ring of channels (107) which is intermingled with a central channel (104).

23. The multichannel element as claimed in claim 22, characterized in that the ring of channels comprises 3 or 4 channels.

24. The multichannel element as claimed in either of claims 22 and 23, characterized in that the central channel has the general shape of a triangle.

25. The multichannel element as claimed in claim 24, characterized in that said ring consists of three channels in the shape of an orange segment.

26. The multichannel element as claimed in any one of claims 22 to 25, characterized in that the external outline of said element is circular.

27. The multichannel element as claimed in any one of claims 1 to 26, characterized in that the channel (104) and/or the rings (202, 302, 303, 504; 203, 303, 304, 502; 107) are intermingled at least in pairs.

28. A method of manufacturing a multichannel element as claimed in any one of claims 1 to 27, in which said multichannel element is obtained by extrusion.

29. A filtration membrane comprising a multichannel element as claimed in any one of claims 1 to 27, in combination with at least one filtering layer.

30. A reaction and/or filtration module comprising at least one multichannel element as claimed in any one of claims 1 to 27 or at least one membrane as claimed in claim 29.
